(19) United States
(12) Patent Application Publication
(10) Pub. No.: US 2019/0198997 A1
(43) Pub. Date: Jun. 27, 2019

(54) POOLING OF AN ANTENNA AND OF A CONVERTER FOR SUPPLYING POWER TO AN ELECTRONIC CIRCUIT

(71) Applicant: COMMISSARIAT A L'ENERGIE ATOMIQUE ET AUX ENERGIES ALTERNATIVES, Paris (FR)

(72) Inventors: Yohan WANDEROILD, MEYLAN (FR); Armande CAPITAINE, Grenoble (FR); Adrien MOREL, Grenoble (FR); Gaël PILLONNET, PROVEYSIEUX (FR)

(21) Appl. No.: 16/226,503

(22) Filed: Dec. 19, 2018

(30) Foreign Application Priority Data
Dec. 22, 2017 (FR) 1763119

(51) Int. Cl. H01Q 7/06; H01Q 9/42

(52) U.S. Cl. CPC H01Q 7/06; H01Q 9/42

(57) ABSTRACT

An autonomous electronic system includes two input terminals that are connected to an external electrical energy source, a converter circuit comprising at least one inductive element and connected to the terminals in order to receive energy from the source, a means for storing the energy delivered by the converter circuit, an electronic processing circuit performing a predefined function and delivering a data signal after performing the function, an emission circuit connected to an antenna in order to transmit the data signal to a remote receiver, and a control circuit able to control the circuits supplied with power by virtue of the energy source, the system being wherein the converter circuit and the antenna comprise at least one common inductive element and in that it comprises a link device situated between the emission circuit and the at least one common inductive element so as to transmit the signal emitted by the antenna formed at least partly by the at least one common inductive element.

### CROSS-REFERENCE TO RELATED APPLICATIONS

This application claims priority to foreign French patent application No. FR 1763119, filed on Dec. 22, 2017, the disclosure of which is incorporated by reference in its entirety.

### FIELD OF THE INVENTION

The invention belongs to the field of autonomous electronic systems comprising an electronic circuit intended to regularly transmit data to a remote receiver.

### BACKGROUND

An autonomous electronic system is capable of recovering, in its environment, the electrical energy that it needs to perform the function for which it is predefined (measuring an environmental parameter, signalling its presence by sending an identifier, etc.) and communicate wirelessly with a remote receiver. Such systems are used for example in IOT systems. The autonomous electronic system may be connected to various types of electrical energy source that draw their electrical energy from a chemical, mechanical, solar, thermal energy source, etc.

Such autonomous electronic systems are often connected to an energy source that delivers a low amount of energy with regard to the energy that the system requires to perform its function, for example perform a measurement, and then emit the item of measurement data. It is thus necessary to accumulate energy in a storage means before activating the electronic measurement and emission circuits. The measurement and emission circuits are generally put into “standby” mode and “awoken” only when the energy stored is enough for them to be able to operate under correct conditions (measurements +emission).

In the marine environment, biocells or microbial fuel cells may be used to supply power to autonomous sensors that are present at the bottom of seas and oceans. These biocells convert chemical energy into electrical energy by virtue of a redox reaction that takes place between marine sediments, containing notably enzymes and living organisms, and seawater. This leads to the occurrence of a voltage across the terminals of the biocell, which makes it possible to supply power to a sensor that will gather data. These data are then transmitted, through the marine environment (wirelessly), to a receiver present on the surface and/or on the coastline by virtue of an underwater antenna.

Moreover, on account of the high attenuation of the waves and of their speed in water, frequencies lower than 30 kHz are used to transmit data using the underwater antenna. An antenna of several tens of metres is therefore necessary (Zhang et al, “The impact of antenna design and frequency on underwater wireless communications”, Communications, Computers and Signal Processing (PacRim), IEEE Pacific Rim Conference, 868-872, August 2011). These biocell systems are therefore particularly bulky.

Furthermore, beyond marine applications, the electronic components necessary to produce an autonomous system may prove voluminous and burdensome in some application contexts.

### SUMMARY OF THE INVENTION

The invention aims to rectify the abovementioned drawbacks of the prior art, and it aims to propose, more particularly, a compact and less burdensome autonomous sensor system. This system may be utilized in a marine environment with biocells, but also in any environment with any electrical energy source.

One subject of the invention is therefore an autonomous electronic system comprising two input terminals that are able to receive wired electrical connections, connected to an external electrical energy source, a converter circuit connected to the two input terminals in order to receive electrical energy from said external electrical energy source, the converter circuit comprising at least one inductive element, a means for storing the energy delivered by the converter circuit, an electronic processing circuit performing a predefined function when the energy stored in said storage means is greater than a predefined value, and delivering a data signal after performing said function, an emission circuit connected to an antenna in order to transmit said data signal to a remote receiver, and a control circuit able to control said circuits; wherein the set of circuits is supplied with power from said external electrical energy source and wherein the average power drawn from the external electrical energy source is lower than the average power necessary for the electronic processing and emission circuits to perform said function and send the corresponding data; the system is characterized in that said converter and the antenna comprise at least one common inductive element, and in that the system comprises a link device situated between the emission circuit and said at least one common inductive element so as to allow the signal that is to be emitted to be transferred by the antenna formed wholly or partly by said at least one common inductive element.

According to particular embodiments of the invention:
the system may furthermore comprise a device for interrupting the operation of the converter circuit, making it possible to isolate said at least one common inductive element and to dedicate it solely to forming an antenna, and wherein the control circuit is able to control the interruption device and the link device so as to configure the common inductive element as an antenna or as an inductor for the converter circuit, respectively;
the system may receive, from said electrical energy source, a substantially DC voltage, and the converter circuit may be of step-up or step-down type and comprise a coil as well as at least one switch that is commanded so as to be alternately in the on state or in the off state depending on a chopping frequency, and said coil may be used wholly or partly as an emission antenna;
the link device may comprise two switches each situated between an output of the emission circuit and a connection point of said at least one common inductive element;
the converter circuit and the emission circuit may operate at the same time, and the frequency of the emission signal may be substantially different from the internal operating frequency of said converter circuit; and
said at least one inductive element of the converter circuit may comprise a magnetic core and, when said at least one common inductive element is used as an antenna, the magnetic core is saturated by a saturation device.

According to another embodiment of the invention, the converter circuit may include a transformer comprising a primary winding and a secondary winding, all or part of the primary and secondary windings constituting said antenna.

In this embodiment:
the converter circuit may also be of flyback type and comprise at least one control switch connected to the primary winding of the transformer, the control switch being commanded so as to be alternately in the on state or in the off state depending on a chopping frequency;
the transformer may be an air-core transformer; and
the system may receive, from said electrical energy source, an AC voltage that is applied to the primary winding of the transformer.

### BRIEF DESCRIPTION OF THE DRAWINGS

Other features, details and advantages of the invention will emerge upon reading the description, given with reference to the appended figures which are given by way of example, and in which, respectively:

FIG. 1 shows a diagram illustrating the principle of the invention;

FIG. 2 shows a system for supplying power to a sensor according to a first embodiment of the invention;

FIG. 3 shows a system for supplying power to a sensor according to a second embodiment of the invention;

FIG. 4 shows a system for supplying power to a sensor according to a third embodiment of the invention;

FIGS. 5a and 5b show an inductive element according to two other embodiments of the invention;

FIG. 6 shows a system for supplying power to a sensor according to a sixth embodiment of the invention; and

FIG. 7 shows a system for supplying power to a sensor according to a seventh embodiment of the invention.

### DETAILED DESCRIPTION

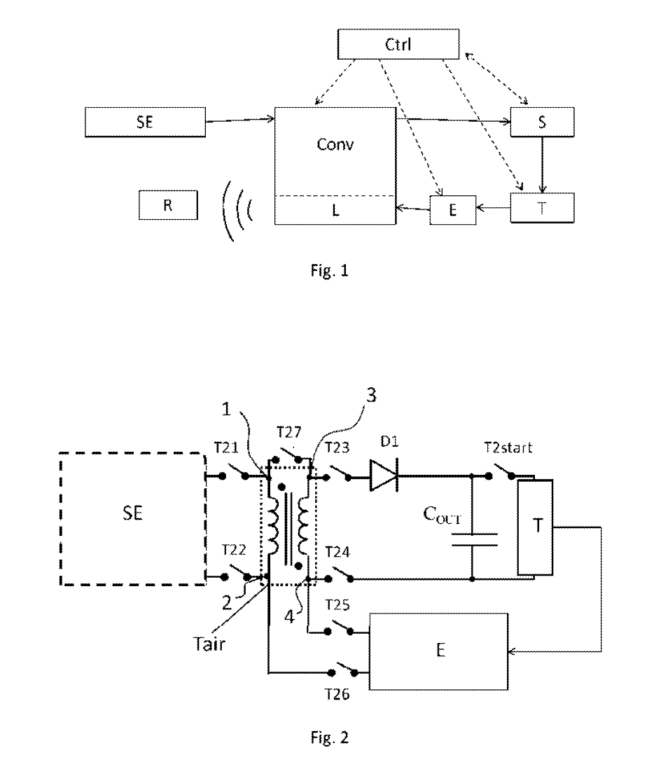

FIG. 1 shows a diagram illustrating the principle of the invention. An energy source SE produces electrical energy, which is recovered by a converter Conv that comprises at least one inductive element L for converting electrical energy. The energy delivered by the converter is stored in a storage means S. When there is enough energy stored in S, an electronic processing circuit T is supplied with energy so as to perform a predefined function, for example perform a measurement using sensors or indicate an identifier. The electronic processing circuit T then supplies data, for example measurement data, to an emission circuit E, which then sends these data by wireless communication to a receiver R. According to one aspect of the invention, the emission circuit E uses all or part of the inductive element L of the converter as an antenna for sending the data. This pooling of the inductive element L thus makes it possible to no longer have an antenna separate from the inductive elements that are present in the converter Conv, and therefore to have an autonomous electronic system that is more compact overall.

The autonomous system according to the present invention may be used in various applications. Depending on the targeted application, and notably the targeted emission frequency and the chopping frequency of the converter, the element dimensioning of the inductive components will be either wireless emission or the transfer of energy via the converter. Thus, the choice of the type of converter and of the type of antenna are dependent on one another, one of the components being more or less constrictive depending on the application contemplated.

In the context of a marine application, such as the one presented above and in relation to the use of biocells for supplying power to a set of underwater sensors, the dimensioning element is the size of the emission antenna, as the emission is performed at low frequency (lower than 30 kHz).

Land-based applications requiring long-distance transmission, at a relatively low frequency, may be performed using a device similar to the abovementioned marine device.

For higher-frequency land-based applications, autonomous systems emitting in the megahertz (MHz) or even the gigahertz (GHz) may be contemplated. In this case, the dimensioning element will rather be determined by the inductive elements of the converter present in the converter.

Various combinations of converter circuit and of antenna type are described hereinafter, with DC or AC, high-voltage or low-voltage electrical energy sources, with emission devices having an emission frequency close to or very different from the variation frequency of the signals at the terminals of the inductive elements of the converter (chopping frequency or AC voltage frequency).

It will be noted that, for all autonomous electronic systems according to the invention, the average power supplied by the energy source SE is significantly lower than the average power necessary for the operation of the circuits for processing and for emitting the corresponding data, which explains why it is necessary to accumulate energy in the storage means before activating these processing and emission circuits.

FIG. 2 shows an autonomous electronic system according to a first embodiment of the invention. The energy source SE is for example a source delivering a low energy, for example a microbial fuel cell delivering around 1 V, in the form of a substantially DC voltage. In this example, the converter is of flyback type and comprises an air-core transformer Tair, a plurality of switches T21, T22, connected to the terminals 1 and 2 of the primary and T23 and T24 connected to the terminals 3 and 4 of the secondary of the transformer Tair, as well as a diode D1 between the switch T23 and the output of the converter. The electrical energy supplied by the converter is then stored in a capacitor C_{OUT}. A switch T2start is in this example situated between the capacitor C_{OUT} and the supply terminal of the processing circuit T and of the emission circuit E. When the switch T2start is put into the on state by the control circuit, after detection of a sufficient level of charge of the capacitor C_{OUT}, the processing circuit is supplied with power and is thus able to carry out the processing that it has to perform, for example measurements of the surrounding environment. The measurement data are then transmitted to the emission circuit E. The emission circuit E is connected to the coils of the transformer Tair by way of a link circuit. This link circuit in this example comprises a switch T26 situated between a first output of the emission circuit E and the terminal 2 of the transformer, a switch T25 situated between a second output of the emission circuit E and the terminal 4 of the transformer, as well as a switch T27 situated between the terminals 1 and 3 of the transformer T. The autonomous system furthermore comprises a control circuit, not shown, which commands the various switches. This control circuit is supplied with power by a specific power supply, or preferably by a rechargeable power supply device that draws its energy from the energy source.

In an energy recovery phase, the switches T21, T22, T23 and T24 of the flyback converter are commanded by the control circuit, in a conventional manner, and preferably so as to maximize the transfer of energy (point commonly called MPPT). The flyback converter will for example raise the output voltage of the biocell to 2 or 3 V. During the energy recovery phase (active converter), the switches T25, T26, and above all the switch T27 of the link circuit are opened so as not to disrupt the operation of the converter. The “raised” voltage delivered by the converter makes it possible to charge the capacitor C_{OUT} to a voltage that then makes it possible to supply power to the processing circuit T. In this processing phase, the switch T2start is closed. Advantageously, it is possible to continue recovering energy while at the same time supplying power to the processing circuit T. Once the processing has been performed by the processing circuit T, emitting the data using the emission circuit E requires using the inductive elements of the transformer to form the emission antenna. During this emission phase, the converter is interrupted, the switches T21 to T24 are in the off state, and the link circuit is activated, the switches T25 to T27 being put into the on state. The two coils, primary and secondary, of the transformer are put in series so as to form the emission antenna.

With a biocell as energy source SE, the energy recovery phase makes it possible to recover a power of between 10 μW and 100 μW for a duration of 1 to 10 s. A sensor, which in this example constitutes the processing circuit T, is supplied with power and performs measurements as soon as the energy in the capacitor C_{OUT} is 100 μJ. The measurement and emission phase generally lasts between 1 and 10 ms. When the measurements are transmitted from the sensor via the emitter E, the two inductors of the air-core transformer Tair then form an antenna that is large enough to allow sending of the measurements from the sensor to a receiver situated nearby or several tens of kilometres away.

According to one variant embodiment, only one of the inductive elements of the air-core transformer Tair is used to form the transmission antenna. The switch T27 is then redundant and the switch T26 is for example connected to the terminal 3 of the transformer, the secondary thus constituting the emission antenna. According to another variant, it is possible to use only part of a primary or secondary coil, the number of switches and their position being adjusted in order to connect the emission circuit to this coil part used to form an antenna.

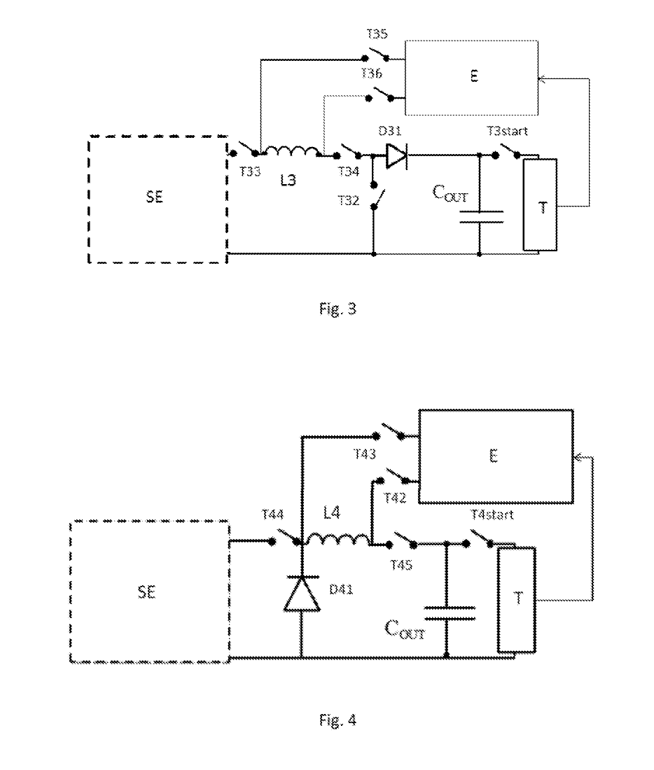

FIG. 3 shows an autonomous electronic system according to another embodiment of the invention, which in fact constitutes a variant of the system described in FIG. 2. The converter is in this case of step-up type, for example of boost type. The converter comprises an inductor L3, switches T33, T34 and T32 and a diode D31. The system comprises, as above, a capacitor C_{OUT}, a switch T3start, a processing circuit T and an emission circuit E. The emission circuit E is connected to the coil L3 by way of a link circuit. This link circuit in this example comprises two switches T35 and T36 situated between an output of the emission circuit E and a terminal of the coil L3, respectively. As above, a control circuit (not shown) commands the various switches.

In a phase of recovering energy using the boost converter, the switches T33, T34, T32 are commanded by the control circuit, in a conventional manner, and preferably so as to maximize the transfer of energy (point commonly called MPPT). As above, the energy is stored in the capacitor C_{OUT} and the processing circuit T is called upon when the energy stored in the capacitor C_{OUT} is enough to allow the circuit T to perform the processing that it has to execute. At the moment of the transmission of the data by the emitter E, the converter is deactivated and the link circuit is activated so that the coil L3 is used as an antenna. The switches T33 and T34 are opened, and then the switches T35 and T36 are closed.

In the exemplary system described above and illustrated in FIG. 3, the two switches T33 and T34, situated on either side of the coil L3, are not necessary to form the converter, the switch T32 and the diode D31 being the two conventional elements of the “boost” converter. The switches T33 and T34 are used in practice to isolate the coil L3 from the energy source SE and from the other components of the converter, respectively, in the emission phase. As a variant, the diode D31 and the switch T34 could have been replaced with a single transistor situated at the location of the diode, this single transistor being put into the on state in the energy recovery phase during the phases of transferring the energy accumulated in the coil to the capacitor.

FIG. 4 shows an autonomous electronic system according to another embodiment of the invention, which in fact constitutes another variant of the system described in FIG. 2. The converter here is of step-down type, for example of buck type. The converter comprises a coil L4 and switches T44 and T45 situated on either side of the coil L4, and a freewheeling diode D41. The system comprises, as above, a capacitor C_{OUT}, a switch T4start, a processing circuit T and an emission circuit E. The emission circuit E is connected to the coil L4 by way of a link circuit. This link circuit in this example comprises two switches T42 and T43 situated between an output of the emission circuit E and a terminal of the coil L4, respectively. As above, a control circuit (not shown) commands the various switches.

When energy is recovered using the buck converter, the switches D41, T44 and T45 are commanded by the control circuit, in a conventional manner, and preferably so as to maximize the transfer of energy (point commonly called MPPT). As above, the energy is stored in the capacitor C_{OUT} and the processing circuit T is called upon when the energy stored in the capacitor C_{OUT} is enough to allow the circuit T to perform the processing that it has to execute. At the moment of the transmission of the measurements by an emitter E, the converter is deactivated and the link circuit is activated so that the coil L4 is used as an antenna. The switches T44 and T45 are opened, and then the switches T43 and T42 are closed.

In the exemplary system described above and illustrated in FIG. 4, only one of the two switches T44 and T45 situated on either side of the coil L4 is in fact necessary to form the buck converter, the switch T44 and the diode D41 being the two conventional elements of the “buck” converter. The transistor T45 is used in practice to isolate the coil L4 from the other components of the converter in the emission phase. When an air-core transformer is used, it may emit an electromagnetic field that may enter into conflict with electromagnetic compatibility (EMC) standards. In a marine environment, this is not generally a concern. By contrast, if the autonomous electronic system is used in an environment other than a marine environment, this may be disruptive or even prohibitive to use thereof. It is for this reason, according to another embodiment of the invention, that the magnetic elements of the converter comprise a magnetic core for channelling the emitted magnetic fields and avoiding undesired emissions. For example, the air-core transformer is replaced with a magnetic-core transformer, or the inductor, present in the boost and buck converters, comprises a magnetic core. The magnetic core makes it possible to channel the electromagnetic field emitted by the transformer or the inductor, and to increase the value of the inductance or of the magnetizing inductance for a transformer, in the phase of recovering energy using the converter. In the emission phase, it is nevertheless necessary to allow the magnetic field to escape in order to emit the signal to the remote receiver. The magnetic core is then saturated during use of the inductor or of an inductive element of the transformer as an antenna.

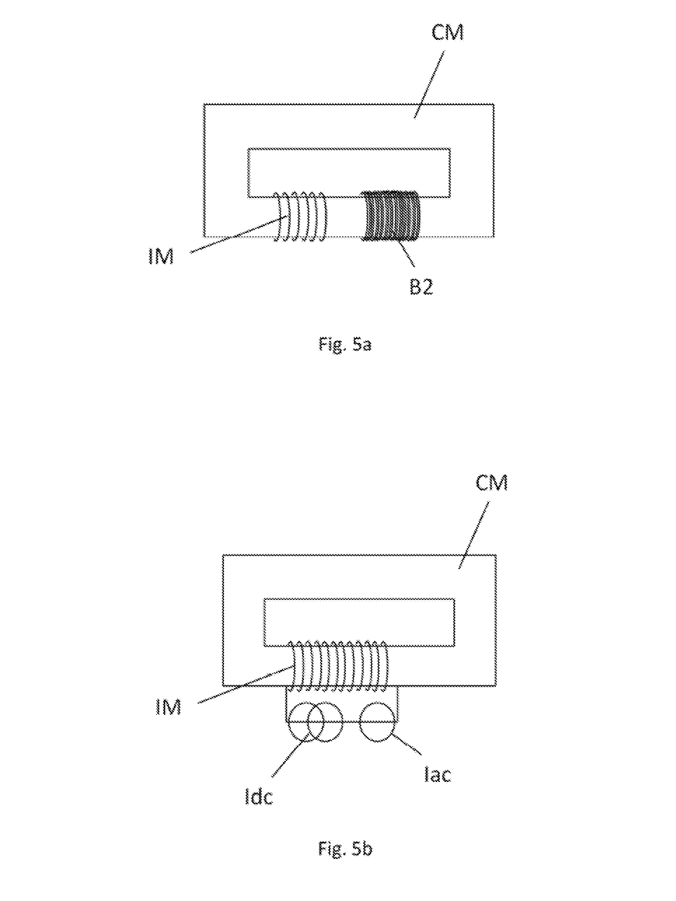

FIGS. 5a and 5b both schematically illustrate a magnetic core CM and, wound around this core, a coil IM that corresponds to an inductive element of the converter used to form the antenna. In order to be able to emit, the electronic system comprises a means for saturating the magnetic core and thus allowing electromagnetic radiation, as the magnetic core no longer confines the “additional” field that goes beyond the maximum field able to be channelled by the magnetic core. Magnetic saturation may be achieved by using, in a coil wound around the magnetic core, a “high” DC current Idc or an AC current Iac also having a “high” peak value. In the example of FIG. 5a, the currents Idc or Iac are injected directly into the inductive element IM used as an antenna. In the example of FIG. 5b, a second coil B2, different from the one used to form the antenna, is situated around the core CM. The coil B2 may be flowed through by a DC or AC current for the purpose of saturating the magnetic core and of allowing the other coil IM to emit a magnetic field. It is possible for example to use the primary of a transformer to saturate the core and emit using the secondary. Such a saturation current may be injected by a dedicated circuit and controlled by the emission circuit or the control circuit in an emission phase. One example of a dedicated circuit, or saturation circuit, comprises for example a capacitor Cs that is recharged, such as the capacitor C_{OUT}, during an energy recovery phase, and that is then discharged into a coil (IM or B2) during the emission phase, this discharge corresponding to the injection of a substantially DC current. Another example of a saturation circuit using a current Iac is described with reference to FIG. 7.

In the examples described above, the converter is stopped during the data emission phase. The inductive element shared by the converter and the antenna is not used at the same time to convert energy and to emit data. There may be many reasons for this. In the case of the system of FIG. 2, putting the primary and the secondary in series is clearly incompatible with use of the transformer to recover energy. In the case of the systems shown in FIGS. 3 and 4, it may potentially be contemplated to superimpose an emission and a recovery of energy by way of a few adjustments and operating conditions of the system. Thus, to contemplate the superimposition, it is necessary for the frequency of the emission signals and the chopping frequency of the buck or boost converters to be highly different to contemplate superimposing a high emission frequency and a low chopping frequency on one and the same coil. Furthermore, so as not to impair the operation of the converter, it is necessary to provide “low-frequency” isolation between the coil L3 or L4 and the emission circuit E, for example by way of a filtering capacitor.

Examples of systems for superimposing the emission/energy recovery functions are given hereinafter.

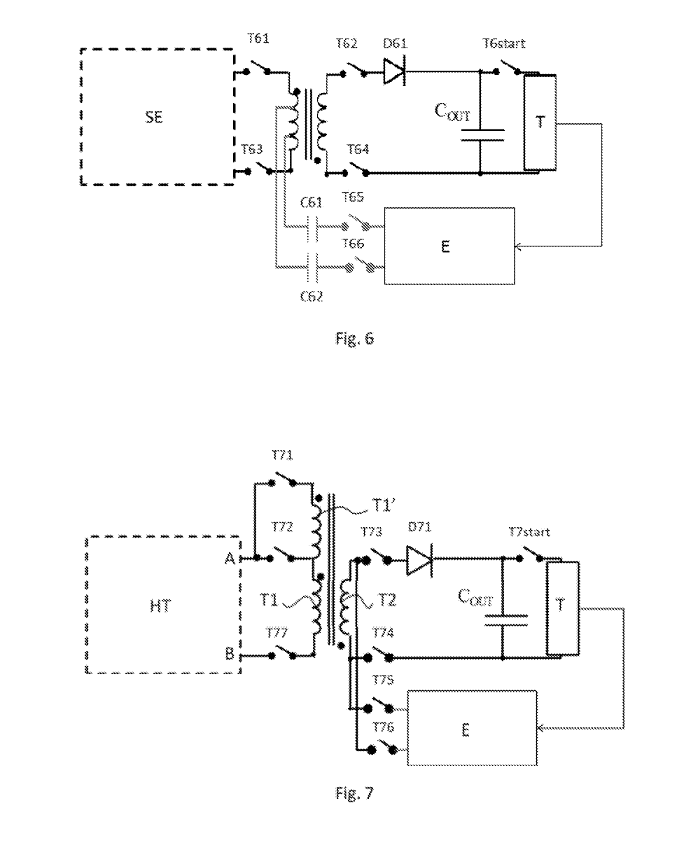

FIG. 6 illustrates an autonomous electronic system according to one variant embodiment of the system shown in FIG. 2, in which the link circuit is formed differently. The link circuit comprises firstly a capacitor C61 and a switch T65 in series between a first output of the emission circuit and a first point of the primary of the transformer T, and secondly a capacitor C62 and a switch T66 in series between a second output of the emission circuit and a second point of the primary of the transformer T. Thus, in this embodiment, when the measurements are transmitted, part of the inductive element of the primary of the transformer is used as an antenna by the emission circuit E. The frequency of the data signal emitted by the emission circuit E is far greater than the operating frequency of the converter (frequency of the AC signal emitted by the energy source and received by the transformer) and the two capacitors C61 and C62 make it possible to filter the “low-frequency” signal flowing through the transformer.

In the examples described above, the energy source delivers a substantially DC voltage. The present invention may also be implemented with an AC voltage source. One example of an autonomous electronic system using an AC voltage source is given hereinafter.

FIG. 7 illustrates an autonomous electronic system according to another embodiment of the invention in which the energy source is for example a high-voltage HV AC grid. The system comprises a converter including a transformer comprising two primary windings T1 and T1′ in series and a secondary winding T2. Three switches T77, T72 and T71 are connected to a distal end of the primary T1, to a common link point of the primaries T1 and T1′, and to a distal end of the secondary T1′, respectively. The switch T77 is moreover connected to a terminal B and the switches T72 and T71 are both connected to a terminal A. The terminals A and B in this example are connected to a phase wire of the HV source (which generally includes three phases and a neutral) and to another phase wire or to the neutral, respectively. Furthermore, the link device in this example comprises two switches T75 and T76 situated between an output of the emission circuit and a terminal of the secondary T2, respectively. In an emission phase, the secondary T2 is used as an emission antenna.

In a phase of recovering energy without emission of data, the switch T71 is opened, the primary T1 and the input voltage are such that the internal magnetic core of the transformer is not saturated. The transformer has very good transfer efficiency.

In a phase of recovering energy with emission of data, the switch T71 is closed and the switch T72 is opened. The AC signal at the terminals of the “enlarged” primary T1+T1′ leads to a phenomenon of saturation of the magnetic core in periods of maximum amplitude of the AC signal, “peak periods”. The transfer efficiency of the transformer is then slightly worse during these peak periods, but it is then possible to emit a magnetic field outside the transformer. By taking an emission frequency far higher than the operating frequency of the converter, the emission circuit is able to emit its data signal during these peak periods of the AC signal coming from the HV source.

It will be noted that, in all of the examples illustrated above, the converters comprise a number of switches connected to the inductive elements that is greater than the number of switches actually necessary to perform the desired conversion function, in flyback, boost and buck. These “additional” switches make it possible to be able to more effectively isolate the inductive elements that contribute to forming the emission antenna from the rest of the system (source SE, capacitor, etc.), so as to make it possible in practice to form a better antenna. For some applications, a person skilled in the art will be able to contemplate not having a switch connected to each terminal of an inductive element constituting the antenna, if the connection of this terminal is not constrictive for forming the antenna.

Furthermore, the switches used in all of the systems described above may be formed by way of transistors or relays. The diodes may possibly correspond to the natural diode that is present in the substrate of a power transistor.

A person skilled in the art will easily be able to adjust the present invention to other types of energy source. The energy source that is used may be dedicated entirely to the autonomous electronic system, notably when the energy source delivers a low amount of energy (case of the biocell). As an alternative, the energy source may not be dedicated to the autonomous electronic system according to the invention, but rather dedicated to another use (case of the high-voltage voltage source HV) and, in this case, the energy draw is as low as possible so as to be “non-intrusive” and as least disruptive as possible, and aims to recover only the energy necessary to perform a processing function with a time interval between two operations. The time interval between the processing operations will be, in the first case (low energy source), more often than not variable and dependent on the energy source, and in the second case more often than not at time intervals that are predefined according to the application.

According to other embodiments of the invention, the energy storage means is a supercapacitor or an electrochemical battery.

Furthermore, the autonomous electronic system could include a data emission and reception circuit, as is possible in an IOT autonomous electronic system. To this end, the receiver circuit of the autonomous system has to “listen”, from time to time, to ascertain whether a message emitted by a remote emitter is intended for it, using the antenna to receive such a message.

In addition, in all of the examples described above, the link device comprises switches ((T25/T26); (T35/T36); (T43/T42); (T65/T66); T75/T76)) situated between the emission circuit E and the antenna. If the outputs of the emission circuit are at high impedance outside the emission phases (or reception phases where applicable), it is possible to contemplate a link circuit without such switches, for example only with link wires or else a filtering circuit, such as capacitors (C61, C62 in FIG. 6).

Furthermore, the autonomous electronic systems described above are in practice formed on one and the same electronic board or situated in one and the same enclosure. The system thus comprises at least two input terminals intended to receive wired electrical connections connected to an external energy source capable of supplying a voltage and/or a current between the two terminals. Inside the autonomous electronic system, the two input terminals are connected to the converter circuit. It will be noted that all of the elements of the converter, and notably its inductive elements, form part of the electronic system and are connected mechanically.

1. An autonomous electronic system comprising:
two input terminals that are able to receive wired electrical connections, connected to an external electrical energy source;
a converter circuit connected to the two input terminals in order to receive electrical energy from said external electrical energy source, the converter circuit comprising at least one inductive element;
a means for storing the energy delivered by the converter circuit;
an electronic processing circuit performing a predefined function when the energy stored in said storage means is greater than a predefined value, and delivering a data signal after performing said function;
an emission circuit connected to an antenna in order to transmit said data signal to a remote receiver; and
a control circuit able to control said circuits;
wherein the set of circuits is supplied with power from said external electrical energy source and wherein the average power drawn from the external electrical energy source is lower than the average power necessary for the electronic processing and emission circuits to perform said function and send the corresponding data;
wherein said converter and the antenna comprise at least one common inductive element, and in that the system comprises a link device situated between the emission circuit and said at least one common inductive element so as to allow the signal that is to be emitted to be transferred by the antenna formed wholly or partly by said at least one common inductive element.

2. The autonomous electronic system according to claim 1, furthermore comprising a device for interrupting the operation of the converter circuit, making it possible to isolate said at least one common inductive element and to dedicate it solely to forming an antenna, and wherein the control circuit is able to control the interruption device and the link device so as to configure the common inductive element as an antenna or as an inductor for the converter circuit, respectively.

3. The autonomous electronic system according to claim 1, wherein the converter circuit includes a transformer comprising a primary winding and a secondary winding, all or part of the primary and secondary windings constituting said antenna.

4. The autonomous electronic system according to claim 1, receiving, from said electrical energy source, a substantially DC voltage, and wherein the converter circuit is of step-up or step-down type and comprises a coil as well as at least one switch that is commanded so as to be alternately in the on state or in the off state depending on a chopping frequency, and wherein said coil is used wholly or partly as an emission antenna.

5. The autonomous electronic system according to claim 3, receiving, from said electrical energy source, a substantially DC voltage, and wherein the converter circuit is of flyback type and comprises at least one control switch connected to the primary winding of the transformer, the control switch being commanded so as to be alternately in the on state or in the off state depending on a chopping frequency.

6. The autonomous electronic system according to claim 3, receiving, from said electrical energy source, an AC voltage that is applied to the primary winding of the transformer.

7. The autonomous electronic system according to claim 1, wherein the link device comprises two switches each situated between an output of the emission circuit and a connection point of said at least one common inductive element.

8. The autonomous electronic system according to claim 1, wherein the converter circuit and the emission circuit may operate at the same time, and wherein the frequency of the emission signal is substantially different from the internal operating frequency of said converter circuit.

9. The autonomous electronic system according to claim 3, wherein said transformer is an air-core transformer.

10. The autonomous electronic system according to claim 1, wherein said at least one inductive element of the converter circuit comprises a magnetic core, and wherein, when said at least one common inductive element is used as an antenna, the magnetic core is saturated by a saturation device.
